(19) United States
(12) Patent Application Publication
(10) Pub. No.: US 2012/0141231 A1
(43) Pub. Date: Jun. 7, 2012

(54) DEVICE FOR ALIGNING AND BINDING SHEETS COMPRISING AN INCLINED SUPPORT SURFACE

(75) Inventors: Henri Huotari, Espoo (FI); Iisakki Huotari, Espoo (FI); Lauri Huotari, Espoo (FI); Teemu Launto, Turku (FI)

(73) Assignee: Maping Kommandiittiyhtiö L. Huotari, Espoo (FI)

(21) Appl. No.: 13/145,932

(22) PCT Filed: Jan. 27, 2010
(86) PCT No.: PCT/EP2010/050957

§ 371 Date: Nov. 3, 2011

(30) Foreign Application Priority Data
Jan. 28, 2009 (EP) 09151577.5

(51) Int. Cl. B42C 1/12; B42C 99/00; B42C 9/00

(52) U.S. Cl. 412/20; 412/33; 227/19

(57) ABSTRACT

A machine (10) for fastening sheets comprises a) a fastening platform (11, 12, 13), which i) comprises a support surface (12) inclined with respect to the horizontal plane (x-y) which optionally also comprises extension means for the support surface, and ii) comprises an alignment surface (13), which is located at the bottom edge of the support surface or lower than this, in such a way that the intersection of the plane formed by the support surface and the plane formed by the alignment surface is formed, with respect to the support surface, by a threshold (100) extending along the width of the support surface, and b) a fastening unit (14). The machine, the support surface, the alignment surface and the fastening unit are configured to enable a user: a) to place a sheet block (40), which is to be fastened, manually in between the fastening head (50) and the support surface, and preferably also b) to knock the sheet block while positioning it on the fastening platform (11) to even out the bottom edge (42) of the sheet block that lies on the alignment surface.

### FIELD OF THE INVENTION

The invention relates to machines for fastening sheets. These kinds of machines can be used especially to fasten the sheets in a sheet block to each other.

### STATE OF THE ART

Sheets in a block can be joined to each other by stapling or binding, for example. The known stapling and binding machines move the chosen fastening material through the sheets, in which case the sheets are fastened to each other by means of the fastening material. The fastening material can be, for example, staples or thread made from copper, steel, aluminium or some other suitable metal or alloy, and can be coated with a suitable substance to achieve the desired properties.

If the intention is to cover the block of sheets fastened to each other, it is advantageous for the sheets to be fastened to each other at one edge so that the edge is as even as possible. The evenness of the edge is significant for the quality of the end product, such as a book.

The generally known stapling machines used for fastening sheets operate in such a way that the sheets in the block are fastened to each other with staples by shooting the staples from top to bottom through the block. The edge of this kind of block is not usually very even, especially when the block is somewhat thick. Since the sheets must also be stapled to each other at several points along the block's edge for the purpose of covering, the unevenness of the edge results in the covered end product often failing to meet expectations.

Owing to the geometry of stapling machines, great accuracy and care is required of their users in order for the edge of the sheet block to become as even as possible. From this, it follows that the fastening of sheets using state-of-the-art solutions is burdensome to the user, in addition to which the quality of the end product often leaves much to be desired.

### PURPOSE OF THE INVENTION

The purpose of the invention in accordance with the independent claim is to improve the using ergonomics of a machine suitable for fastening sheets. Thus, it may also be possible to achieve a better stapling result with less need for accuracy and care.

The dependent claims describe inventive embodiments and those that are advantageous for the implementation of the machine.

### ADVANTAGES OF THE INVENTION

If a machine for fastening sheets comprises i) a fastening platform comprising a support surface inclined with respect to the horizontal plane, and an alignment surface at a suitable angle, such as a right angle, with respect to the support surface which is located at the bottom edge of the support surface or lower than this, in such a way that the intersection of the plane formed by the support surface and the plane formed by the alignment surface is formed, with respect to the support surface, by a threshold extending along the width of the support surface, and ii) a fastening unit comprising a fastening head extending from below the plane formed by the alignment surface to above the plane formed by the alignment surface, and operating devices which are suitable for activating the fastening head to move fastening material in such a way that the fastening material penetrates through the sheets (=the sheet block) set in a block against the support surface from their bottom edge at a suitable distance (d) from the alignment surface in the direction of the alignment surface or at some suitable angle with respect to the alignment surface, it is possible to utilize the force of gravity to even out the sheet block and keep it in place. The user ergonomics can be improved considerably, if the machine, the support surface, the alignment surface and the fastening unit are configured to enable a user to place a sheet block, which is to be fastened, manually in between the fastening head and the support surface. The user ergonomics can be further improved, if the machine, the support surface, the alignment surface and the fastening unit are configured to enable a user to knock the sheet block while positioning it on the fastening platform to even out the bottom edge of the sheet block that lies on the alignment surface.

This enhances the using ergonomics in the case when the fastened sheet block should have as even an edge as possible, for example. When the fastening head extends from below the plane formed by the alignment surface to above the plane formed by the alignment surface, it may be technically easier to implement such a machine embodiment that allows eye contact to be maintained with the sheet block to be fastened and preferably also with its bottom edge to be stapled.

The machine can optionally comprise extension means for the support surface. If the machine fastens different sizes of sheets into sheet blocks, not so much space will be needed for the machine when it is out of use, for example.

The machine preferably also comprises a counter element of the fastening head above, or extending from below to above, the plane formed by the alignment surface. This enhances the machine's practicality in the case, for example, that the fastening unit comprises stapling and/or binding devices.

The machine's use may be eased if the fastening head and/or the counter element of the fastening head extends from inside the machine, through the opening in the alignment surface, to above the plane formed by the alignment surface, and/or if the fastening head and/or the counter element of the fastening head extends, through the opening in the support surface, to above the plane formed by the alignment surface, since it is thus possible to use the support surface to support the sheet block to be fastened also during fastening.

The using ergonomics are enhanced very much if the fastening head is accessible without impediment from above the machine

If the fastening unit comprises a stapling device, it is possible to implement a sheet fastening device by using a mechanism that is quick and needs relatively little maintenance, and possibly also such in which the sheet-fastening speed is sufficiently quick considering the machine's economic use. A particularly advantageous embodiment is, indeed, such in which the stapling device in the machine is a normally commercially available and/or electrically-driven stapling device.

The sheet fastening machine can be implemented compactly if the stapling device is adapted to shoot staples inside the sheet fastening machine by a pendulous motion occurring around an axis located below the alignment surface. This also makes it possible to use simpler vibration damping in the stapling device and thus may increase the ease of use of the machine.

Noise and vibration are reduced if the stapling device is suspended inside the machine while using damping means such as rubber pads, for example. Depending on the implementation, this may have great significance for the machine's usability, since, due to the support surface's position inclined from the horizontal, it would be difficult in a very strongly vibrating machine to keep in place the sheets to be stapled, especially if the alignment surface is rather narrow compared with the sheet block to be fastened. With the aid of the damping devices the noise level is reduced when using the machine.

The machine can also comprise a protective cover located on the fastening head which is movable in the direction of the plane of the alignment surface and/or which is preferably at least partly transparent and/or comprises a transparent viewing window. The movability makes it possible to adjust the distance of the protective cover from the support surface, which improves user safety, since the fastening head can thus be protected better when fastening thin sheet blocks or if there are no sheets at all, for example. Transparency or a transparent viewing window helps in maintaining eye contact during fastening of the sheets.

As the protective cover can be opened, it is possible to replenish the fastening materials in the machine by changing the staple cassette in the stapling device, for example.

The using ergonomics are enhanced if the machine's support surface and/or alignment surface are, in the direction of the threshold, freely accessible from both sides of the fastening unit. In manufacturing terms this is implemented most advantageously in such a way that the machine comprises at least one bent plate which forms the shape and/or direction of both the support surface and the alignment surface. Due to the free accessibility, the fastening of even large-sized sheets is possible. Thus it is possible to fasten sheets with a longer leaf into a sheet block, even though the longer leaf would be longer than the width of the support surface or alignment surface.

The inventors have noticed in particular that, when using a bent plate, the quality of the sheet block's fastening improves significantly if one or more plates are added to the bent plate in order to straighten the rounding created in the plate during bending, since a rounded bending of the plate easily leads to the formation of uneven alignment in the fastened edge of the sheet block. Especially if the machine is a bookbinding machine—as, for example, in the case that the machine also comprises a book covering unit—it is a significant advantage that the end result is better suited for bookbinding.

Because one property of the machine is the adjustability of the penetration distance of the fastening material, the machine's using possibilities for the fastening of sheet blocks suitable for different purposes are enhanced. Structurally, the most simple way is to add, on top of the bent plate, one or more plates as extension plates. This allows the penetration distance to be adjusted step by step.

The machine can be adapted to move the support surface, and/or the sheet block set on the support surface, in the direction of the threshold in relation to the fastening head. In addition to this, or alternatively, the machine can be adapted to even out, by vibrating, the sheet block to be set on the fastening platform. Thus it is possible, at least partly, to automate the fastening procedure so there is less need for the user to intervene in the fastening event.

According to one advantageous embodiment, the machine comprises a control unit. From the perspective of the efficiency and possible adaptability of production, the most meaningful way is to implement the control unit as an electronic control unit. Thus the desired additional properties can most simply be implemented in the machine.

The control unit can be adapted to activate the fastening head by means of a foot pedal connectable to the machine by a wire or wirelessly. With the foot pedal the user can use both hands to support the sheet block and thus possibly focus better on the fastening event.

In addition to or instead of this, the control unit can be adapted to activate the fastening head, depending on the disconnect position of a switch possibly in the machine, such as a micro-switch for example. Thus it is possible to enhance the using ergonomics and/or using safety, or, if the switch is used to activate the fastening head, it is possible to use the fastening head only when there is fastening material in the activation area of the switch.

The control unit can be adapted to transmit operating power to the fastening unit and/or to the fastening head. This possibility is very advantageous when the control unit is adapted to activate the fastening head in the way presented in one or both of the previous paragraphs.

The control unit can also be adapted to transmit operating power to a signal light, a light and/or lights in the machine, especially to such light that is arranged to illuminate one or more of the following: the counter element of the fastening surface, the support surface, the opening of the alignment surface, the opening of the support surface and/or the fastening head. Heating and power consumption will decrease if the light or lights are implemented as light-emitting diodes (LED).

Particularly in using fastening material made of metal and/or that conducts electricity, it is advantageous if the control unit is located in the vertical position and/or is insulated by a protective cover from the fastening unit. This is in order to avoid short circuits in the control unit caused by the fastening material. According to one advantageous embodiment the protective cover comprises a chute-like part which leads to the bottom of, or outside, the machine, because such a relatively simple system of removing the fastening material from the machine can lengthen the machine's maintenance intervals.

If the machine comprises at least one supply compartment behind or below the support surface, it is possible to improve the ease of use. With this arrangement, the supplies in the supply compartment do not form an impediment to the fastening event. The machine's front surface can also remain free and can thus be utilized for a covering unit, for example.

The machine can comprise a covering unit below the plane formed by the alignment surface and/or in front of the fastening unit. Thus it is possible to use the same machine to both fasten the sheets into sheet blocks and cover the blocks fastened, which makes it possible to acquire one machine fewer or to save space in the machine's working environment.

Since it is often desired for aesthetic reasons that the book covers are bigger than the sheet block fastened in the covers, the covering is easier if the machine comprises a covering unit which comprises at least one edging batten, on the inner edge of which is at least one protruding part which leaves an indent groove between the protruding part and the machine. Covering with covers of different thicknesses and often also of slightly different sizes produces an aesthetically better end result if the height of the indent groove with respect to the edging batten is adjustable by using adjusting devices. To achieve more exact adjustment, it is good to use adjusting devices such as adjustment screws, for example, that are suitable for exact adjustment.

If the machine comprises an auxiliary surface and, above the auxiliary surface, a holding element such as a holding strip, which forms a holding groove between itself and the auxiliary surface for holding the book to be covered, the using ergonomics are enhanced when using sticker covers, for example, since the book can be placed in the holding groove during the removal of the sticker's protective paper.

If the covering unit comprises a front plate, to which at least one of the mentioned edging strips is fastened, and if the shape of the front plate makes it possible to freely access the holding groove in the direction of the auxiliary surface in front of the machine, it is possible to implement both the indent groove and the holding groove so that they are effortlessly accessible when the user is standing or sitting in front of the machine, for example.

If the indent groove is preferably formed from the protruding part and the front plate, it is possible to implement an especially compact solution that offers the user temporary storage for requisites or covered books.

### LIST OF DRAWINGS

The detailed description of the invention below describes the structure of a machine according to the invention in more detail using the drawings presented in the Figures to illustrate one advantageous embodiment of the machine.

The accompanying drawings present:

FIG. 1 a machine for fastening sheets;

FIG. 2 the machine presented in FIG. 1 in which there is, in part, a sheet block whose sheets are fastened to each other partly at the edge of the sheet block;

FIG. 3 a machine for fastening sheets which has means for enlarging on a support surface;

FIG. 4 a machine which comprises a covering unit which contains a book cover and, placed on top of the cover and partly glued to the cover, a sheet block whose sheets are first fastened to each other at the edge of the sheet block;

FIG. 5 the machine presented in FIG. 3 viewed from the front;

FIG. 6 the machine presented in FIG. 3 shown as a cross-section A-A from the left-hand side;

FIG. 7 the machine presented in FIG. 3 viewed from the right-hand side;

FIG. 8 a detail of the embodiment of the support surface and alignment surface presented in FIG. 7; and

FIG. 9 an exploded view of a fastening unit and its installation base which shows one embodiment of the fastening unit's fastening; and

FIG. 10 an assembly view of the machine's frame;

FIG. 11 an assembly view of the fastening base; and

FIG. 12 an assembly view of the machine;

FIG. 13 an enlargement of a detail presented in FIG. 8.

The same reference numbers refer in all drawings to the same or like structural parts.

### DETAILED DESCRIPTION OF THE INVENTION

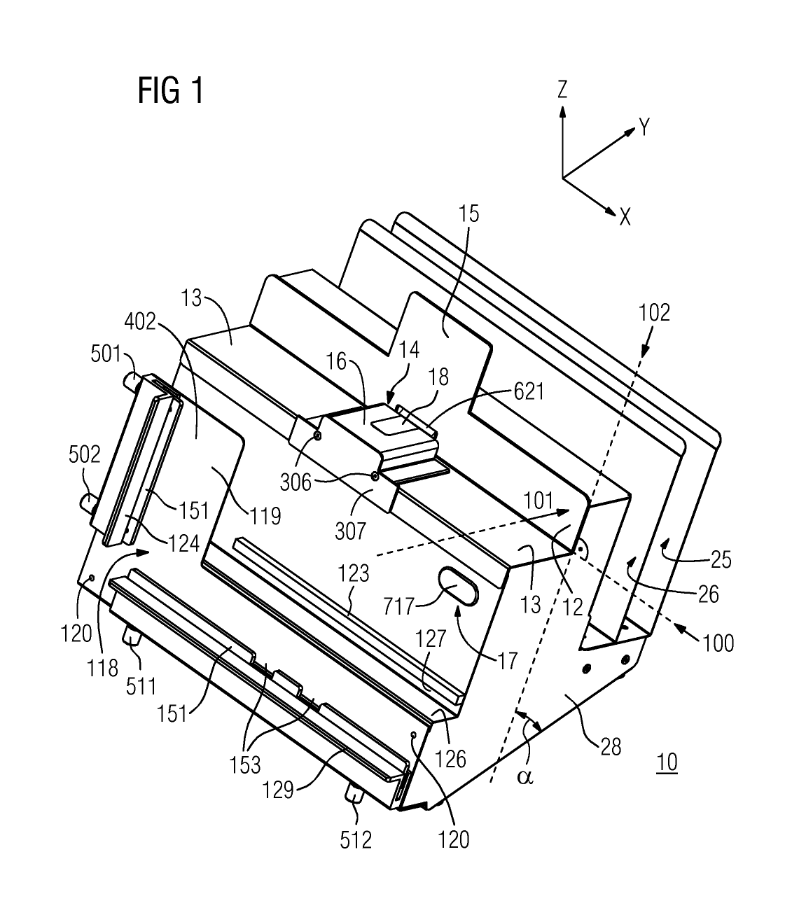

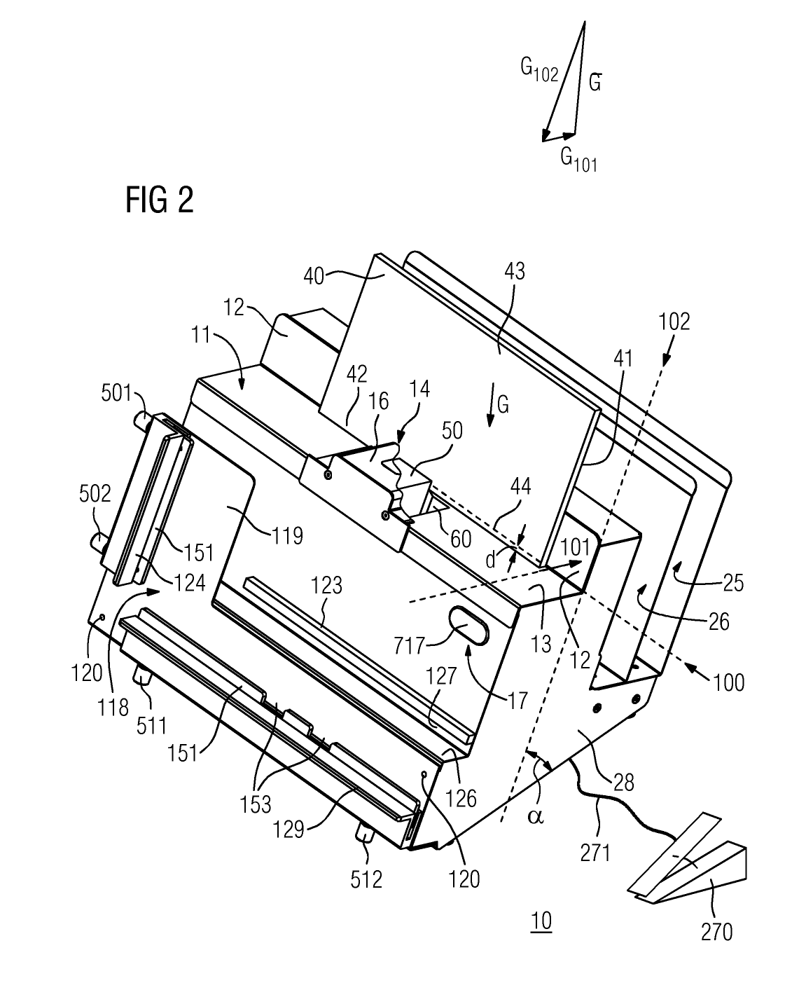

FIGS. 1 and 2 present a machine 10 for fastening sheets. The machine 10 has a fastening platform 11 comprising a support surface 12 and an alignment surface 13, a fastening unit 14, and, in accordance with one embodiment, also one or more supply compartments 25, 26 and/or a covering unit 118. The supply compartment or compartments 25, 26 are located most advantageously behind or below the support surface 12.

In the embodiment of the invention described, the fastening unit 14 comprises a stapling device that is suitable for stapling paper. The fastening material 44 used is preferably staples that are made of metal or contain metal and that may be coated.

It is possible, however, within the scope of the inventive idea, to also create a fastening head 50 by means of suitable equipment other than a stapling device, such as, for example, a binding device. In this case, the fastening materials 44 used would be materials suitable for the fastening head, such as thread.

The fastening platform 11 comprises a support surface 12 inclined with respect to the horizontal plane x-y and an alignment surface 13 which is at right angles to the support surface 12. The alignment surface 13 is located at the bottom edge of the support surface 12, so that the intersection of the plane formed by the support surface 12 and the plane formed by the alignment surface 13 is formed, with respect to the support surface 12, by a threshold 100 extending along the width of the support surface 12.

The threshold 100 forms at least one projection from the plane formed by the support surface, projecting out from it so that a sheet block 40 set against the threshold 100 to the support surface 12 of the fastening platform 11 will not slip downwards.

The support surface 12 has a projection 15 at the location of the fastening unit 14 which ensures better support for the sheet block 40 to be fastened.

The straight line 102 is drawn in the plane of the support surface 12 and at right angles to the threshold 100. The angle of inclination a of the support surface 13 from the horizontal plane (the angle between the straight line 102 and the horizontal plane x-y) is most advantageously 65 degrees and preferably between 50 and 80 degrees.

The purpose of the embodiment of the threshold 100 and the support surface 12 and the alignment surface 13 is that a sheet or sheet block 40 to be set in the machine 10 in the way presented in FIG. 2 will stay in place and will not slip away from the support surface 12 in an uncontrolled manner.

With respect to the force of gravity G to be applied to the sheet block 40 set in the machine 10 in the way presented in FIG. 2, one component—the component G₁₀₁ being in the direction of the straight line 101 cutting through the support surface 12—will press the back 41 of the sheet block 40 against the plane of the support surface 12, while the other component—the component G₁₀₂ being in the direction of the straight line 102—will press the bottom edge 42 of the sheet block 40 against the plane of the alignment surface 13.

The threshold 100 extends most advantageously in the horizontal plane x-y and preferably forms, when the side wall 1001 is vertical with respect to the horizontal plane x-y, a right angle with the side wall 1001 of the machine frame 28. However, the side wall 1001 can also be in an inclined position with respect to the vertical.

When the sheet block 40 is fastened by the fastening material 44 at a first point, the position of the sheets with respect to each other is locked in the side direction. For ease of use, it is advantageous to coat the support surface 12 and possibly also the alignment surface 13 with a sufficiently slippery material, so that the sheet block 40 can be slid along the support surface 12 and the alignment surface 13. It has been noticed that a good end result will be achieved by powder coating, using a material containing a polymer such as plastic as the material to be sprayed.

According to one advantageous embodiment, the alignment surface 13 can also be located lower than the bottom edge of the support surface 12.

The fastening unit 14 comprises a fastening head 50 extending from below the plane formed by the alignment surface 13 to above the plane formed by the alignment surface 13.

In addition, the machine 10 comprises a foot pedal 270 connectable to the machine 10 by a cable 271. The foot pedal 270 has been adapted to activate the fastening head 50 to move the fastening material 44, so that the fastening material 44 penetrates through the sheet block 40 set against the support surface 12 from said sheet block's bottom edge 42 at a distance d from the alignment surface 13 in the direction of the alignment surface 13. Instead of a cable 271, the foot pedal 270 can also be technically implemented wirelessly by, for example, using a radio connection to the machine 10.

The machine 10 is used most advantageously in such a way that the sheet block 40 is possibly knocked while positioning the sheet block 40 on the fastening platform 11, so that the bottom edge 42 of the sheet block 40 that lies on the alignment surface 13 will be even. It is most advantageous to place the sheet block 40 on the fastening platform 11 in as central a position as possible.

After this the foot pedal 270 is pressed, whence the fastening head 50 moves the fastening material 44—in the case of a stapling device shoots a staple—through the sheet block 40 in the direction of the straight line 101 shown in FIGS. 1 and 2. After this the sheet block 40 is shifted a little, after which the foot pedal 270 is pressed again. The shifting of the sheet block 40 and the pressing of the foot pedal 270 is repeated sufficiently many times that the bottom edge 42 of the sheet block 40 is fastened along the whole sheet length, for example.

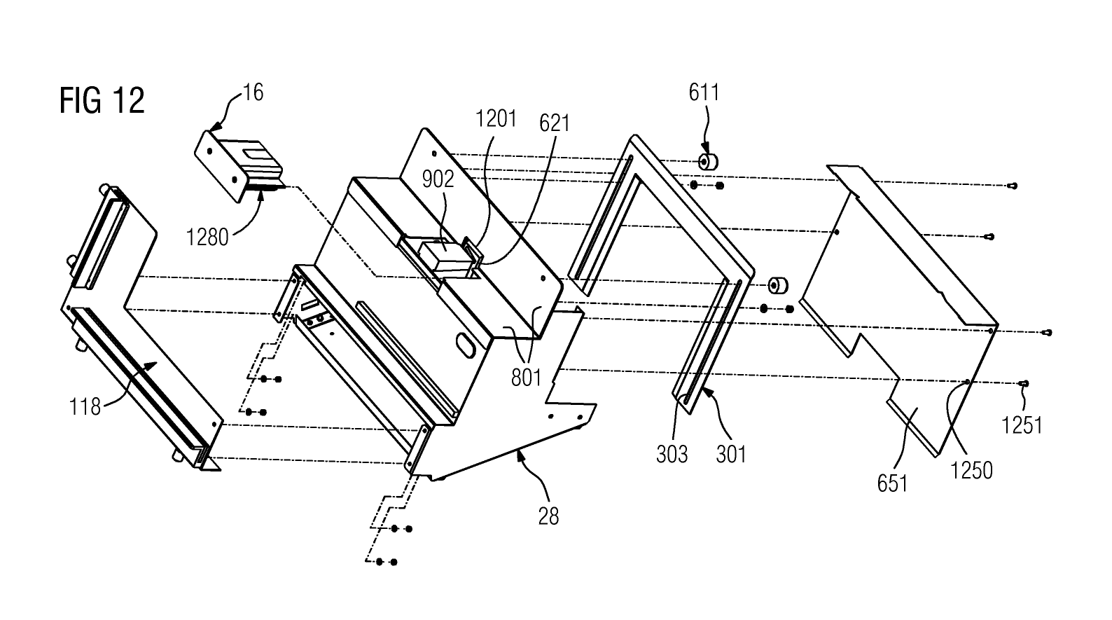

The fastening head 50 extends through the opening 60 in the alignment surface 13 to above the plane formed by the alignment surface 13. The special counter element 621 of the fastening head 50—for example, in the case of a normal stapling device, a matrix used to clinch the ends of the staples—extends through the opening 1201 (see FIG. 12) in the support surface 12 above the plane formed by the alignment surface 13. The fastening head 50 is adapted to move fastening material 44 towards the support surface.

For an alternative embodiment, it is possible to implement machine 10 by turning the fastening head 50 by 180 degrees and to exchange the locations of the opening 60 and the opening 1201. In that case, the fastening head 50 will thus extend through the opening in the support surface 12 to above the plane formed by the alignment surface 13. Correspondingly, the special counter element 621 of the fastening head 50 will extend through the opening in the alignment surface above the plane formed by the alignment surface 13. In that case, the fastening head 50 is suited for moving the fastening material 44 away from the support surface 12.

Due to safety perspectives, activating the fastening head 50 may require, when setting the sheet block 40 on the fastening platform 11, an adjustment of the protective cover 16 of the fastening head 50 of the fastening unit 14 so that the protective cover 16 comes against the sheet block 40, or that the protective cover 16 does not at least have a pre-adjusted—by for example about 10 mm—or an adjustable distance further from the support surface 13. The purpose of the protective cover 16 is to prevent the user's fingers from getting into the working area of the fastening head 50. The protective cover 16 is preferably movable in the direction of the plane of the alignment surface 13 so that operating safety would be maintained in stapling sheet blocks 40 of different thicknesses, and is preferably at least partly transparent. Alternatively or in addition to this, the protective cover 16 can comprise a transparent viewing window 18. This allows eye contact to the working area 888 of the fastening head 50.

It is possible to place a warning sticker on the protective cover 16 to warn the user of the danger of touching the working area 888 when the machine 10 is ready for use.

Because the protective cover 16 is movable, it is possible to add fastening material 44 to the fastening unit 14. At its most simple, this occurs by exchanging in the fastening unit 14 a staple cassette 902 containing fastening material 44 such as staples.

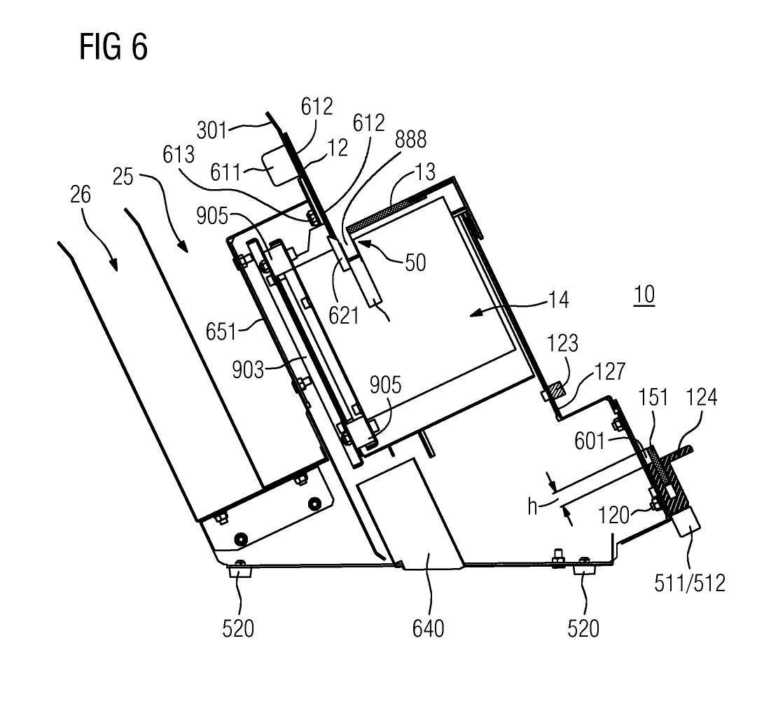

According to one advantageous embodiment, the machine 10 comprises a covering unit 118 below the plane formed by alignment surface 13 and at the same time also in front of the fastening unit 14. The covering unit 118 comprises an edging batten 129 below and, according to one advantageous embodiment, also an edging batten 124 at the side. The inner edge of the edging batten 124, 129 has at least one protruding part 151 which leaves an indent groove 601 (see also FIG. 6) between the protruding part 151 and the machine 10. The height h of the indent groove 601 with respect to the edging batten 124, 129 is adjustable by using the adjusting devices 501, 502, 511, 512 which may be adjustment screws or corresponding, for example. The covering unit 118 is attachable to the machine 10 by fastening devices 120 such as screws for example, so that the covering unit 118 can be a separate accessory, in which case the machine 10 can be sold and used also without the covering unit 118.

The covering unit also comprises a front plate 119 in connection with which, or integrated with which is the cover support surface 402. The cover support surface 402 is also inclined from the horizontal plane x-y. The optimal angle of inclination α=65 degrees, but other angles of inclination are also possible. The angle of inclination α is advantageously between 50 and 80 degrees.

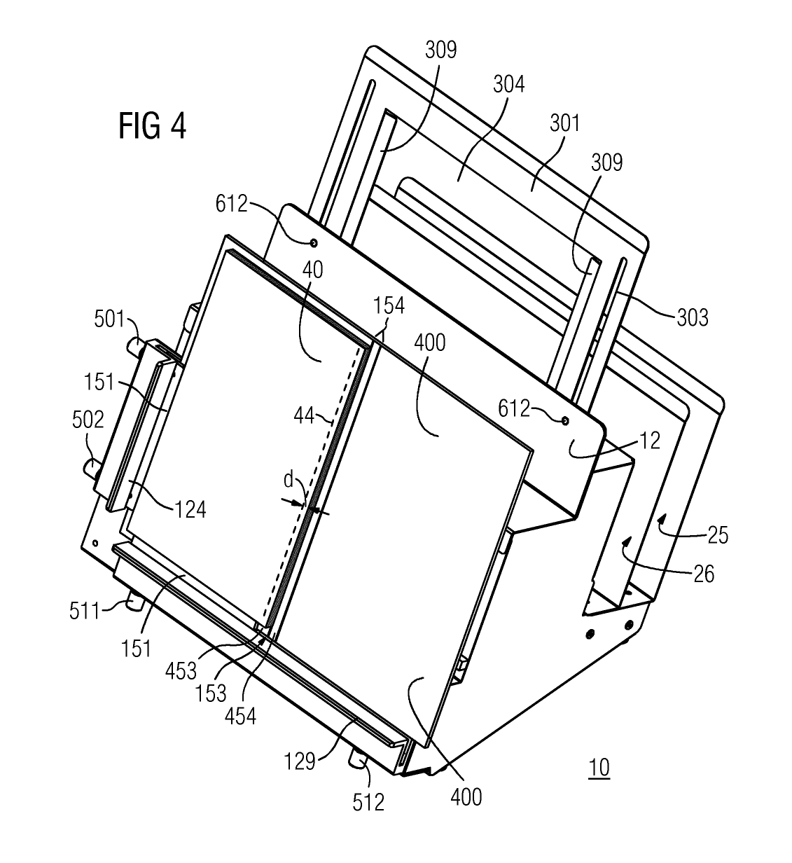

It is also apparent from FIGS. 4-6 that the devices 501, 502, 511, 512 for adjusting the indent grooves 601 are preferably made to move in the batten frame 503, 514 which forms a uniform part of the edging batten 124, 129 and at the same time also the bottom part of the groove 601.

According to one advantageous embodiment, the machine 10 comprises an auxiliary surface 126 and, above the auxiliary surface 126, a holding element 123 such as a holding strip. The holding element 123 forms a holding groove 127 between itself and the auxiliary surface 126 for holding the book to be covered.

According to one advantageous embodiment, at least one edging batten 124, 129 is fastened to the front plate 119. The best solution is to use at least two edging battens 124, 129 which are at an angle of 90 degrees to each other. The shape of the front plate 119 makes it possible to freely access the holding groove 127 in the direction of the auxiliary surface 126 in the front of the machine 10, and also makes it possible for the indent groove 601 to be preferably formed from the protruding part 151 and the front plate 119. Between the front plate 119 and the machine frame 28 is also a compartment 701 which is primarily for the fingers when the cover 400 is put in place, but which can possibly be also used for the storage and temporary placement of materials and requisites.

The machine 10 also comprises a signal light 17 which indicates the on/off status of the machine 10. If the signal light 17 is made to stand out from the front wall of the machine frame 28, the signal light 17 will be visible from the front, the sides and above.

The signal light 17 is implemented by making an entry hole 1070 in the front wall, such as in the front cover part 703, of the machine frame 28 by drilling or punching, for example, and after that by fastening a lamp 1072 to a holder 1071 by a fastening means 1075—most easily by using a double-sided tape. The holder 1071 is fastened by means of staples 1074, for example, near the entry hole 1070, and a sticker or other covering plate 717 that lets through at least part of the lamp's light is placed as a shade. The brand of the machine or its manufacturer or seller can also be put on the sticker or other covering plate 717, which will thus be lit up whenever the machine 100 is on. To achieve a more even light a shade 1073 is also located between the lamp 1072 and the sticker or other covering plate 717.

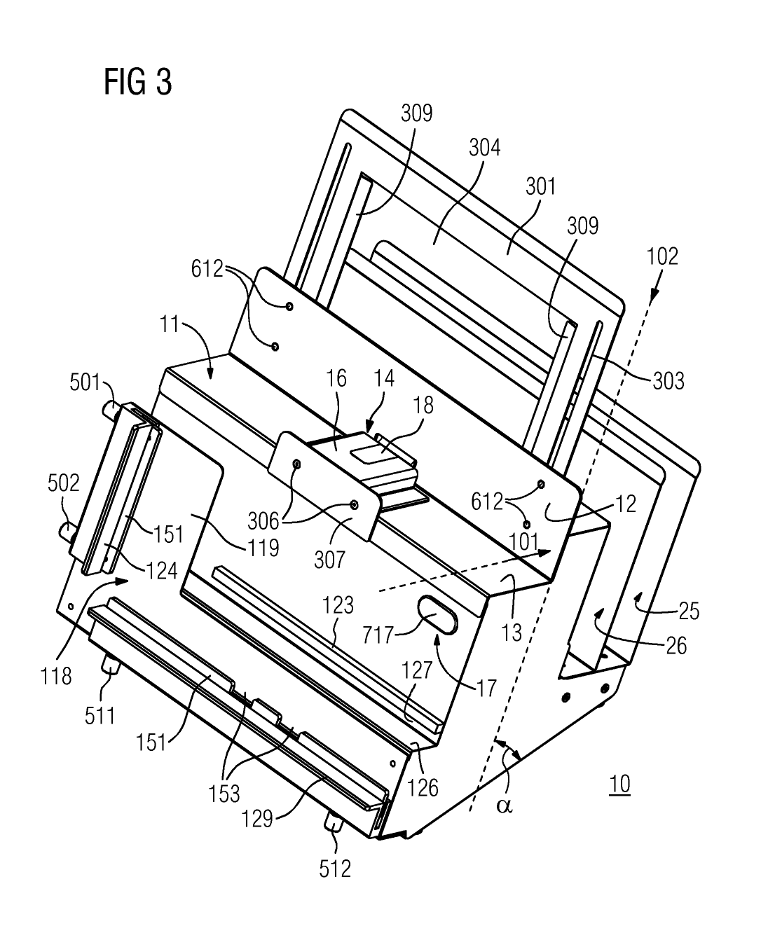

FIG. 3 shows a machine 10 corresponding to the one shown in FIGS. 1 and 2, except that the projection 15 of the support surface 12 is implemented as an extendable projection 301. The projection 301 is preferably made with telescopic adjustment, implemented particularly by an adjusting groove or slot 303 by which the projection 301 can be fixed in place to the desired height as shown in FIG. 6. The projection 301 can be arched or made otherwise so that the shape of the projection 301 leaves the inner part 304 of the projection 301 free. An arched projection 301 which extends outside both sides of the fastening unit 14 ensures better support for the back 41 of the sheet block 40 to be fastened if the sheets are of large size.

The inner edge 309 of the projection 301 is angled inside about 20 degrees. As a result, the edge or corner of the sheet block 40 will not be so easily caught on the edge of the free inner part 304 of the projection 301. The edge turning operation stiffens the projection 301.

The protective cover 16 is fastened to the front plate 307 by using a suitable attachment such as the fastening screws 306, for example.

FIG. 4 presents a machine 10 comprising a covering unit 118 in which there is a (book) cover 400 and, on top of the cover 400, a sheet block 40 the sheets of which were previously fastened to each other on the longer edge with the fastening material 44. The left-hand edge of the cover 400 is placed in the indent groove 601 against the edging batten 124, while the bottom edge is placed in the indent groove 601 against the edging batten 129. Due to the position of the cover support surface 402, the cover 400 is supported on the bottom of the groove 601 of the edging batten 129 aided by the force of gravity.

The sheet block 40 is smoothed out and rests against the protruding parts 151 on its left-hand edge and its bottom edge. Gravity helps the sheet block 40 to stay against the protruding part 151 at its bottom edge and keeps the sheet block 40 in place before it is glued to the cover 400. When the protruding part 151 is made so as to be transparent, it is easier for the user to visually inspect whether the cover 400 is visible by an equal amount above and below the sheet block 40, and whether the sheet block 40 is in the right place laterally with respect to the cover 400.

If necessary, the user is able to adjust the indentation of the sheet block 40 with respect to the cover 400 in the desired manner by using the adjusting devices 501, 502, 511, 512. By using the adjusting devices 501, 502 of the left-hand edge, it is possible to adjust the vertical edges of the sheet block 40 precisely to the desired distance from the spine splinter 154 of the cover 400.

The covering unit 118 provides an excellent working platform for fastening the sheet block 40 to the cover 400 and, for example, for gluing the cover 400.

An opening or openings 153 are left in the protruding part 151 so that it is possible, at the point of the spine splinter 154, to turn the right-hand side of the spine 454 of the cover 400 outside the indent groove 601, and thus to leave the left-hand side of the spine 453 of the cover 400 inside the indent groove 601.

In order that the covering of many different sizes of covers 400 with the covering device 118 will succeed more easily, there may be many openings 153. According to one embodiment, the protruding part 151 is made from small strips which alternate with the openings 153 along the length of the edging batten 129. Thus, there can be many openings 153.

An advantageous covering method comprises the following steps:

i) setting the cover 400 in the covering unit 118 so that the cover 400 touches the groove 601 at its bottom and side edges;

ii) setting on the lower protruding part 151 the fastened sheet block 40, whose top and bottom sheets are each sticker sheets equipped with protective paper;

iii) vertically adjusting the edge of the cover 400 and the margins of the sheet block 40 so that they have the same dimensions;

iv) pressing the sheet block 40 against the protruding part 151 on the side;

v) folding the cover 400 onto the sheet block 40 in such a way that the side edge (the left-hand side edge if using the arrangement shown in FIG. 4) of the cover 400 touches the surface of the sticker sheet;

vi) adjusting the protruding part 151 of the side edge in such a way that the sheet block 40 lightly touches the spine splinter 154;

vii) opening the cover 400, peeling off the protective paper from the visible side of the sheet block 40 to about halfway and folding the cover 400 back closed in such a way that the left-hand edge of the cover 400 touches the surface of the sticker sheet;

viii) pressing the cover 400 lightly with the fingers on the back preferably in the area above the auxiliary surface 126;

ix) turning the sheet block 40 and the cover 400 around;

x) opening the cover 400;

xi) peeling off the protective paper of the sticker halfway and pressing lightly closed;

xii) placing the covered binding in the holding groove 127 under the protrusion 123, and then removing the rest of the protective paper; and

xiii) turning the covered binding and

xiv) repeating steps vii)-xii) for the other side of the covered binding.

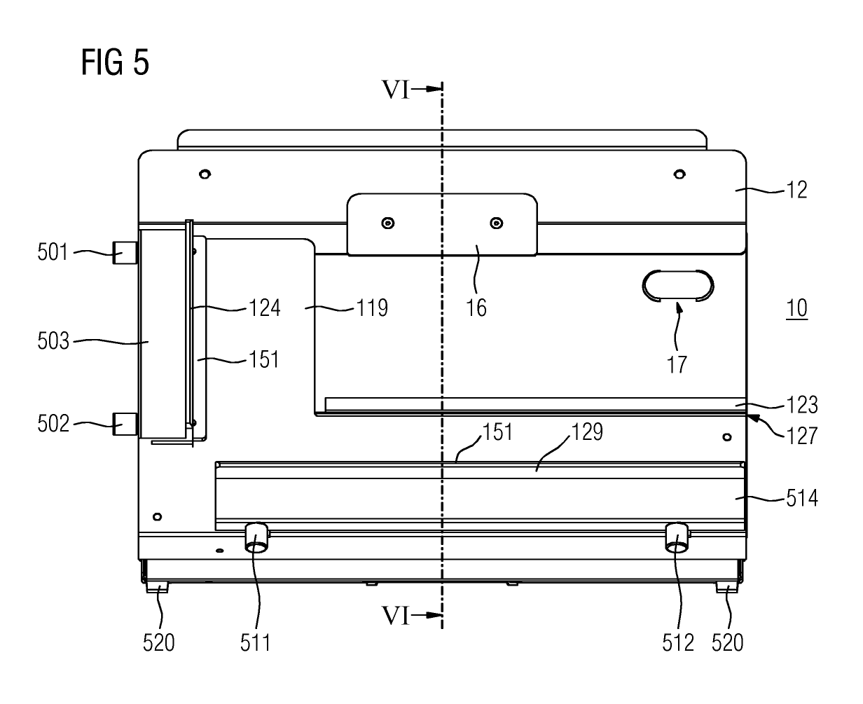

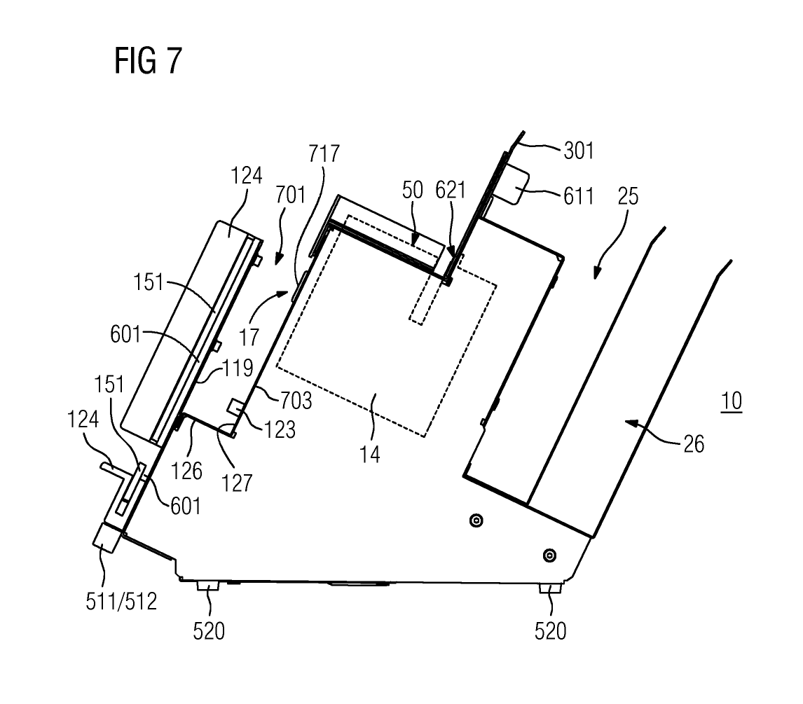

FIG. 5 shows a front view of the machine 10 presented in FIG. 3, while FIG. 7 shows it viewed from the right. FIG. 6 shows a cross-section A-A of the machine 10 viewed from the left.

FIGS. 5-7 better show the way of implementing the holding element 123 and the holding groove 127. They also better illustrate an advantageous way of implementing the fastening unit 14.

The projection 301 can be pulled outwards to enlarge the support surface 12 and can be pushed inwards to diminish the support surface 12. When the projection 301 is at the desired location, the projection 301 can be fixed in place by fastening it with the fastening elements 611, 612, 613 to the adjusting groove or slot 303.

The adjusting groove or slot 303 is most advantageously implemented as a slot, while the fastening elements 611, 612 and 613 are most advantageously implemented respectively as a hand-knob screw, a press screw, and a self-locking nut such as a Nyloc (R) nut or more generally as a nylon insert or polymer insert lock nut. The nut is installed leaving a clearance of about 0.3 mm between the projection 301 and the nut 301. The nut ensures that the projection 301 will stay fixed to the machine 10 even if the hand-knob screw is completely unscrewed. The press screws 612 are designed so that their heads do not protrude from the plane 612.

The counter element 621 to the fastening head 50 is preferably a matrix which clinches the ends of the staples used as the fastening material in the desired manner. The counter element 621 is preferably implemented as part of the fastening unit 14.

The fastening unit 14 is suspended inside the machine 10 and uses damping means 905 such as rubber pads, for example. In addition to rubber pads, other materials suitable for quickly damping vibrations, such as sufficiently stiff springs, are suitable as the damping means 905.

The machine 10 stands on feet 520 which are fastened to the base plate 1291 by screws or staples, for example.

The plate 651 is the back plate of the machine frame 28. The plate 651 is fastened to the machine frame 28, as shown in FIG. 12, by suitable fastening devices 1251 such as screws, using the suspension holes 1250 of the plate 651 as an aid.

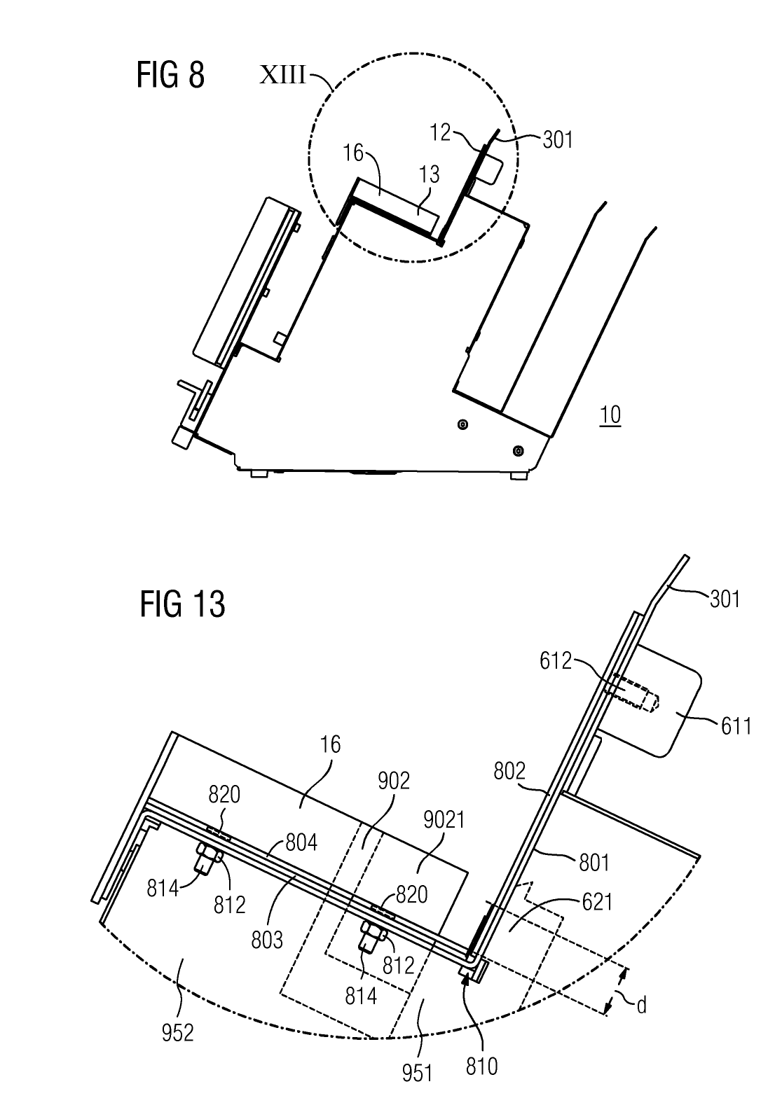

FIG. 8 presents a part, shown in more detail in FIG. 13, of the view of FIG. 7, and illustrates an advantageous embodiment of the support surface 12 and the alignment surface 13. The shape and orientation of the support surface 12 and the alignment surface 13 are formed by the bent plate 801. In order to straighten the rounding 810 created in the plate 801 during bending, one or more extension plates 802, 803, 804 are added onto the bent plate 801 on the support surface 12, or on the alignment surface 13, or on both. The plates 801 and the extension plate 802 are fastened to each other preferably by spot welding.

Due to the location of the fastening unit 14 and the protective cover 16, it is difficult to implement the extension plates 803, 804 as one piece. Because of this, the extension plates 803, 804 to be added onto the alignment surface 12 are chosen and installed in such a way that an equally large raise occurs in both the right-hand and left-hand sides of the fastening unit 14. At its most simple, this occurs in such a way that the extension plates 803, 804 are equally thick on both the left-hand and right-hand sides of the fastening unit 14.

It is advantageous to install the extension plates 803 and 804 separately by, for example, fastening them with fastening elements 820 such as screws 810 through the holes 812 to the counter elements 814 such as the boreholes of the fastening elements. Thus there is the possibility, by changing the quantity and thickness of the plates 803, 804 step by step, to adjust the fastening distance d of the fastening material from the bottom edge 42 of the sheet block 40 as shown in FIG. 8. This embodiment also makes it possible for the support surface 12 or the alignment surface 13 or both to be, in the direction of the threshold 100, freely accessible from one or both sides of the fastening unit 14.

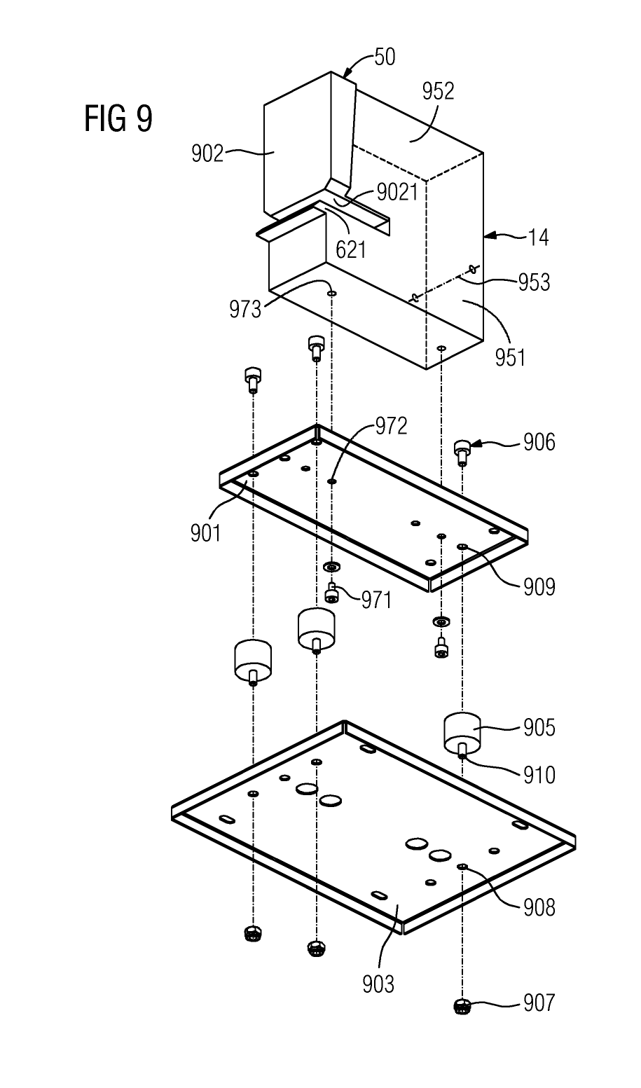

FIG. 9 presents an exploded view of the fastening unit 14 and its mounting plate 903. The fastening unit 14 comprises a stapling device which is preferably a normally commercially available stapling device. Most advantageously the stapling device is adapted to shoot staples inside the machine 10 by a pendulous motion occurring around the axis 953 located below the alignment surface 13.

The stapling device has a fastening head 50 which comprises a staple cassette 902 and a staple exit aperture 9021. The stapling device also has a matrix as a counter element 621, a staple storage compartment omitted from FIG. 9 for the sake of clarity, and an electric drive. The upper part 952 of the stapling device is pivoted with the axis 953 in relation to the lower part 951. The electric drive is adapted to move the upper part 952, in relation to the axis 953, in preferably a pendulous motion in such a way that the upper part 952 shoots, in relation to the staple cassette 902, a staple from the staple storage out of the exit aperture 9021 in the direction of the counter element 621. The counter element 621 clinches the ends of the staple in the desired manner such as overlapping or against each other.

The stapling device is fastened to the base plate 901 by the screws 971 by screwing the screws 971 through the holes 972 in the base plate 901 to the screwing hole 973 in the stapling device.

The base plate 901 is fastened to the mounting plate 903 by means of bolts 906 which are put through the holes 909 in the base plate 901, and through the damping device 905 such as a damping pad, for example, and through the holes 908 in the mounting plate 903. A male screw 910 is put in the hole of the mounting plate 903. After this, the damping device 905 is closed in position by bolts 906 and nuts 907.

Although the fastenings created by using the above-presented separate fastening means allow the machine 10 to be better maintained, it is clear that those skilled in the art are able to use other fastening means than screws or bolts, such as gluing for example, which do not require enabling the detaching of the stapling device. Those skilled in the art are also able to implement the fastening without using damping, or by locating the damping devices between the stapling device and the base plate 901 and/or between the base plate 901 and the mounting plate 903. Instead of the damping pads 905 it is also possible to use one or more centrally located damping pads or mats or other suitable damping devices.

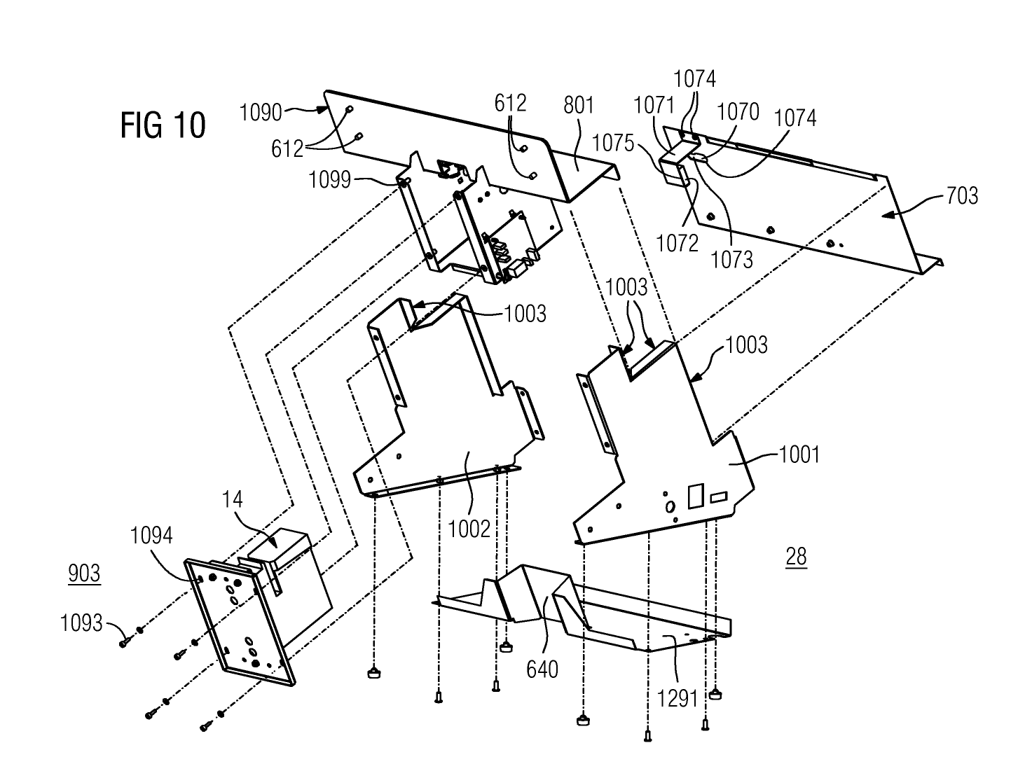

FIG. 10 presents a method of assembling the machine 10. The bent plate 801 and thus the cover part 1090 including the alignment surface 12 are fastened to the side walls 1001, 1002, after which the front cover part 703 is put in place. The fastening unit 14 is fastened to the cover part 1090 from below by fastening the mounting plate 903 by fastening means, for example by screwing the screws 1093 through the holes 1094 in the mounting plate 903 to the holes 1099 in the cover part 1090.

For better vibration and noise damping, it is advisable to put the damping material 1003 between the cover part 1090 and the mounting plate 903. A particularly elegant solution is to use double-sided tape, such as acrylic tape, as the damping material 1003, for in that case there is no need for separate fastening of the damping material 1003 and the tape acts at the same time also as a seal against dust and dirt.

The base 1291 is fastened to the side walls 1001, 1002 either in a detachable way, such as by screwing for example, or permanently such as by stapling for example.

The base 1291 forms a chute 640 whose upper end is located below the working area 888 of the fastening head 50. The task of the chute 640 is to lead any fastening material 44 that falls inside the machine 10 from the working area 888 of the fastening head so that it comes below or outside the machine. For this purpose, the shape of the base 1180 of the cover part 1090 forms a guiding surface 1181 so that the fastening material slides along the cover part 1090. By using the chute 640 presented in FIG. 10, the fastening material 44 that falls will end up to the largest extent below the machine 10.

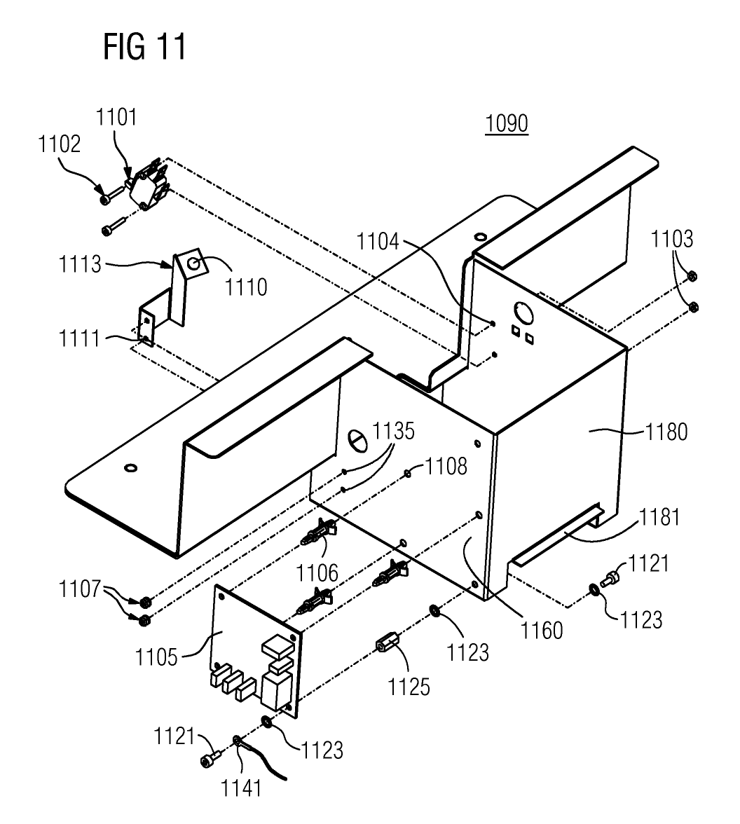

FIG. 11 shows how the control unit 1105 is located in the vertical position. In addition, the side wall 1160 of the cover part 1090 acts as a protective wall preventing any fastening materials 44 that may go astray from the fastening unit 14, particularly from the fastening head 50 and the staple exit aperture 9021, from ending up on the control unit 1105.

The control unit 1105 is fastened to the cover part 1090 on the feet 1106, for example, by pressing the feet 1106 into the holes 1108 in the cover part. The control unit 1105 can also be fastened to the cover part 1090 by screwing a tension screw 1121 with a star washer 1123 into a female spacing sleeve 1125 which conducts electricity. Thus, it is possible to earth the fastening platform 11 by using the earthing of the control unit 1105, which is formed by means of the earthing cable 1141 connected to the control unit 1105, by connecting one end of the earthing cable 1141 to the earthing contact of the current connector of the machine 10. The control unit 105 is adapted to activate the fastening head 50 and particularly the electric drive of the stapling device by means of a foot pedal 270 connectable to the machine 10 by a wire or wirelessly.

The cover part 1090 has a switch 1101 which is preferably implemented by way of a micro-switch. The control unit 1105 is arranged to activate the fastening head 50, depending on the disconnect position of the switch 1101. The purpose of this arrangement is to prevent the activation of the fastening head 50 if the cover 16 has been pulled out. This can be achieved by means of a connecting device, such as a wing or projection 1280 in a wing set in the cover 16 or designed for it, which connects the switch 1101 only when the cover 16 is in place (see FIG. 12); the contacts of the switch 1101 are in that case a normally open contact. The machine 10 may also have other switches, depending on the position of which the control unit 1105 activates the fastening head 50.

In addition, the control unit 1105 is suitable for transmitting operating power to the fastening unit 14, especially to its electric drive and the fastening head 50.

The switch 1101 is fastened, by means of fastening devices 1102, 1103 such as screws and nuts, to the cover part 1090, and preferably to the side wall 1160 of the cover part 1090, by means of the suspension holes 1104, for example.

For reasons of user comfort and safety, the machine 10 may be made not only with the on/off signal light 17, but also with the light 1110 with which it is possible to illuminate the fastening surface's counter element 621, support surface 12 and the openings 60, 1201, or only some of the foregoing.

The light 1110 is installed most advantageously on the holder 1113 which is fastened to the cover part 1090, preferably on the side wall 1160 of the cover part 1090, by using fastening devices 1111, 1107 such as self-tapping screws and fastening holes by which the holder 1113 can be fastened to the suspension holes 1135. It is also possible to illuminate the fastening head 50. To avoid heating, the light 1110 is most advantageously implemented as at least one light-emitting diode, but other kinds of light are also possible.

Automation of the machine 10 is possible, at least partially, if it is adapted to move the support surface 12 and/or the sheet block 40 set on the support surface 12 in the direction of the threshold 100 in relation to the fastening head 50.

To those skilled in the art it is clear that the detailed description of the invention or the form of words chosen for the claims is not meant to restrict the protective scope demanded for the invention. The invention can also be implemented in ways deviating from the embodiment described in the detailed description, while still remaining within the framework of the protective scope of the claims. Instead of the presented electrically-driven stapling device, a simple version of the machine is implementable using a manually driven stapling device.

### LIST OF REFERENCE NUMBERS

10 machine
11 fastening platform
12 support surface
13 alignment surface
14 fastening unit
15 projection
16 protective cover
17 signal light
18 viewing window
25, 26 supply compartment
28 machine frame
40 sheet block
41 back of the sheet block
42 bottom edge of the sheet block
43 top edge of the sheet block
44 fastening materials
50 fastening head
60 opening in the alignment strip
100 threshold
101 straight line through the support surface 12
perpendicular to the threshold 100
102 straight line along the support surface 12
perpendicular to the threshold 100
118 covering unit
119 front plate
120 attachment device
123 holding element
124, 129 edging batten
126 auxiliary surface
127 holding groove
151 protruding part
153 opening in the protruding part
154 spine splinter
270 foot pedal
271 cable
301 projection
303 adjusting groove or slot
304 inner part of projection
306 fastening screw
307 front plate
309 inner edge of projection
400 (book) cover
402 cover support surface
453 left-hand side of the spine
454 right-hand side of the spine
501, 502 adjusting device
503 batten frame
511, 512 adjusting device
514 batten frame
520 pedestal
601 indent groove
611 fastening element (hand-knob screw)
612 fastening element (press screw)
613 fastening element (self-locking nut)
621 counter element to the fastening head
640 chute
651 plate
701 compartment
703 front cover part
717 sticker or other covering plate
801, 802 plate
803, 804 elevation plate
810 rounding
812 hole
814 counter element to the fastening element (screw
cap)
820 fastening element (screw)
888 working area of the fastening head
901 base plate
902 staple cassette
903 mounting plate
905 damping pad
906 bolt
907 nut
908 hole
909 hole
910 male screw
951 lower part of the stapler
952 upper part of the stapler
953 axis
971 screw
972 hole
973 hole
1001, 1002 side wall
1003 damping material
1070 entry hole
1071 holder
1072 lamp
1073 shade
1074 fastening staples
1075 fastening means (double-sided tape)
1090 cover part
1093 screw
1094 hole
1099 hole
1101 switch
1102, 1103 fastening devices (screw, nut)
1104 suspension hole
1105 control unit
1106 foot
1107 fastening device (self-tapping screw)
1108 hole
1110 light
1111 fastening hole
1113 holder
1121 tension screw
1123 star washer
1125 spacing sleeve
1135 suspension hole
1141 earth cable
1160 side wall
1180 base
1181 guiding surface
1201 opening
1250 suspension hole
1251 fastening device
1280 cover projection
1291 base
9021 staple exit aperture

1. A machine (10) for fastening sheets, comprising:
a fastening platform (11, 12, 13), comprising:
a support surface (12) inclined with respect to the horizontal plane (x-y) which optionally also comprises extension means (15, 301, 303, 304) for the support surface (12), and
an alignment surface (13) at a suitable angle, such as a right angle, with respect to the support surface (12), which is located at the bottom edge of the support surface (12) or lower than this, in such a way that the intersection of the plane formed by the support surface (12) and the plane formed by the alignment surface (13) is formed, with respect to the support surface (12), by a threshold (100) extending along the width of the support surface (12); and
a fastening unit (14), comprising:
a fastening head (50, 902, 9021) extending from below the plane formed by the alignment surface (13) to above the plane formed by the alignment surface (13), and preferably also a counter element (621) of the fastening head above, or extending from below to above, the plane formed by the alignment surface, and
operating devices (270, 271, 1101, 1105) which are suitable for activating the fastening head (50, 902, 9021) to move fastening material (44) in such a way that the fastening material (44) penetrates through sheets set in a block (40) against the support surface (12) from their bottom edge (42) at a distance (d) from the alignment surface (13) in the direction of the alignment surface (13) or at some suitable angle with respect to the alignment surface (13);
whereby said machine (10), said support surface (12), said alignment surface (13) and said fastening unit (14) are configured to enable a user: a) to place a sheet block (40), which is to be fastened, manually in between the fastening head (50, 902, 9021) and the support surface (12), and preferably also b) to knock the sheet block (40) while positioning it on the fastening platform (11) to even out the bottom edge (42) of the sheet block (40) that lies on the alignment surface (13).

2. A machine (10) according to claim 1, wherein the fastening head (50, 902, 9021) or the counter element (621) of the fastening head extends, through an opening (60) in the alignment surface (13), from below the plane formed by the alignment surface (13) to above it.

3. A machine (10) according to claim 1, wherein at least one the fastening head (50, 902, 9021) or the counter element (621) of the fastening head extends, through an opening (1201) in the support surface (12), from below the plane formed by the alignment surface (13) to above it.

4. A machine (10) according to claim 1, wherein the fastening platform (11) is accessible without impediment from above the machine (10).

5. A machine (10) according to claim 1, wherein the fastening unit (14) comprises a stapling device (50, 902, 9021, 951, 952, 953, 621)
preferably a normally commercially available and/or electrically driven stapling device—which preferably:
is adapted to shoot staples (44) inside the machine (10) by a pendulous motion occurring around the axis (953) located below the alignment surface (13) and/or
is suspended inside the machine (10) while using damping means (905, 910) such as rubber pads, for example.

6. A machine (10) according to claim 1, comprising a protective cover (16) located on the fastening head (50), which i) is movable in the direction of the plane of the alignment surface (13) and/or which is preferably at least partly transparent and/or comprises a transparent viewing window (18), and/or ii) can be opened, making it possible to replace a staple cassette (902).

7. A machine (10) according to claim 1,
wherein the support surface (12) and/or the alignment surface (13) is/are, in the direction of the threshold (100), freely accessible from one or both sides of the fastening unit (14); and/or
which comprises at least one bent plate (801) which forms the shape and/or direction of both the support surface (12) and the alignment surface (13), to which bent plate (801) is optionally added one or more plates (802, 803, 804) in order to the alignment surface (13), to which bent plate (801) is optionally added one or more plates (802, 803, 804) in order to straighten the rounding (810) created in the plate (801) during bending, and/or in order to adjust the penetration distance (d) of the fastening material (44); and/or
wherein the penetration distance (d) of the fastening material is adjustable; and/or
the fastening platform (11) is formed at least partly by the cover part (1090) of the machine (10) which is supported by the damping material (1003) on the side walls (1001) of the machine (10).

8. A machine (10) according to claim 1, which is adapted:
to move the support surface (12) and/or the sheet block (40) set on the support surface (12) in the direction of the threshold (100) in relation to the fastening head (50); and/or
to even out, by vibrating, the sheet block (40) to be set on the fastening platform (11).

9. A machine (10) according to claim 1, wherein the operating devices (270, 271, 1101, 1105) preferably comprise an electronic control unit (1105) which is adapted:
to activate the fastening head (50, 902, 9021) i) by means of a foot pedal (270) connectable to the machine (10) by a wire or wirelessly, and/or ii) depending on the disconnect position of a switch (1101) possibly in the machine, such as a micro-switch for example; and/or
to transmit operating power to the fastening unit (14) and/or to the fastening head (50, 902, 9021); and/or
to transmit operating power to a signal light, a light and/or lights (1072, 1110) in the machine (10), especially to such light—such as for example at least one light-emitting diode—that is arranged to illuminate one or more of the following: the counter element (621) of the fastening surface, the support surface (12), the opening (60) of the alignment surface, the opening (1201) of the support surface and/or the fastening head (50, 902, 9021).

10. A machine (10) according to claim 9, wherein the control unit (1105) is arranged in a vertical position and/or isolated by a protective cover (1090, 1160, 1099, 1094) from the fastening unit (14) or especially from the fastening head (50, 902, 9021) in order to avoid short circuits caused by the fastening material (44), which protective cover (1090, 1160, 1099, 1094) comprises most advantageously a chute-like part (640) which leads to the bottom of, or outside, the machine.

11. A machine (10) according to claim 1, comprising at least one supply compartment (25, 26) behind or below the support surface (12).

12. A machine (10) according to claim 1, comprising a covering unit (118) for fastening the sheet block (40) to a cover (400) and optionally also for gluing said cover (400), the covering unit (118) located below the plane formed by the alignment surface (13) and/or in front of the fastening unit (14).

13. A machine (10) according to claim 1, comprising a covering unit (118) for fastening the sheet block (40) to a cover (400) and optionally also for gluing said cover (400), the covering unit (118) comprising at least one edging batten (124, 129), on the inner edge of which is at least one protruding part (151) which leaves an indent groove (601) between the protruding part (151) and the machine (10), the height (h) of which indent groove (601) with respect to the edging batten (124, 129) is preferably adjustable by using adjusting devices (501, 502, 511, 512) such as adjustment screws, for example.

14. A machine (10) according to claim 1, comprising an auxiliary surface (126) and, above the auxiliary surface (126), a holding element (123) such as a holding strip, which forms a holding groove (127) between itself and the auxiliary surface (126) for holding a book to be covered.

15. A machine (10) according to claim 13, whose covering unit (118) comprises a front plate (119), to which the at least one edging batten (124, 129) is fastened, and the shape of which front plate (119) makes it possible to freely access the holding groove (127) in the direction of the auxiliary surface (126) in the front of the machine (10), and in which the indent groove (601) is preferably formed from the protruding part (161) and the front plate (119).
